(19) United States
(12) Patent Application Publication
(10) Pub. No.: US 2011/0258134 A1
(43) Pub. Date: Oct. 20, 2011

(54) METHOD AND SYSTEM FOR PROVIDING ADAPTIVE PROCESSING AND DELIVERY OF FOOD CATERING ORDERS

(75) Inventor: Miguel Angel Mendez, Hillsboro, OR (US)

(73) Assignee: KLASSIC CORPORATION, Portland, OR (US)

(21) Appl. No.: 12/761,539

(22) Filed: Apr. 16, 2010

(51) Int. Cl. G06Q 50/00; G06Q 30/00; G06Q 10/00

(52) U.S. Cl. 705/332; 705/15; 705/26.8

(57) ABSTRACT

Embodiments of the invention include a system for providing adaptive processing and delivery of food catering orders. The system includes a computer server configured to store schedule information, a website operatively associated with the computer server to receive food catering orders, and a commissary to produce food elements arranged within one or more boxes. The schedule information includes a delivery zone, at least one delivery shift associated with the delivery zone, and a plurality of time slots associated with the at least one delivery shift, which can be adjusted according to certain inputs. A method includes receiving a food catering order, determining whether a selected time slot within a delivery schedule is available for the order, and either storing information about the order in a server or making an offer for an alternative actions. Embodiments of the invention also include shifting delivery resources between adjacent delivery zones.

### FIELD OF THE INVENTION

This application pertains to food catering, and more particularly, to a method and system for providing adaptive processing and delivery of food catering orders.

### BACKGROUND

Traditionally, food catering is a “mom and pop” type industry whose delivery processes are haphazard and somewhat archaic. Businesses, government agencies, and other organizations are seeking to streamline meetings and other types of gatherings, while providing pleasing arrangements and varieties of food to their employees or guests. Food catering is intended to help facilitate these efforts, but due to their outdated approaches and aversion to the use of improved information technologies, catering companies are not keeping pace with customer needs.

Businesses often use food catering to meet the food consumption needs or desires of employees at the work place. Organizers of special events, such as weddings, banquets, conventions, and the like, frequently make use of the food catering industry. Individual homeowners can purchase catered food items for parties or special occasions, such as holidays, in the home. These are only a few of the many circumstances where food catering might be desirable.

The logistic chain of food catering is complicated because there are many factors that must be considered in order for a quality and reliable service to be provided. Without conscious and organized efforts being devoted to a food catering enterprise, even well-intended labors can deteriorate into chaos and poorly dispensed services. The current food catering industry is notorious for missed schedules, delayed deliveries, poor quality, ruined food, high costs, etc. Many of these challenges stem from a dislocation between order intake, inventory management, delivery capabilities, and scheduling. Accordingly, a need remains for an improved system and method for providing adaptive processing and delivery of food catering orders. Embodiments of the invention address these and other limitations in the prior art.

### BRIEF DESCRIPTION OF THE DRAWINGS

FIG. 1 illustrates an adaptive food catering processing and delivery system including a website, a server, a commissary, and a delivery logistic chain, according to some embodiments of the present invention.

FIG. 2 illustrates a simplified diagram of a scheduling profile associated with a delivery zone in connection with delivery capacity and other factors, according to some embodiments of the present invention.

FIG. 3 illustrates a simplified diagram of various components of an adaptive food catering processing and delivery system according to some embodiments of the present invention.

FIG. 4 illustrates a simplified diagram of multiple delivery vehicles, each having inventory and excess inventory, and including a remote transceiver for communicating with the server of FIG. 1.

FIG. 5 illustrates a simplified diagram of two adjacent delivery zones, and a technique for cross-boundary delivery management, according to some embodiments of the present invention.

FIG. 6 is a flow diagram illustrating a technique for receiving food catering orders and making alternative selections to customers, according to some embodiments of the invention.

FIG. 7 is a flow diagram illustrating a technique for prioritizing customers and filling orders based on the assigned priorities, according to some example embodiments.

FIG. 8 is a flow diagram illustrating a technique for shifting delivery resources between adjacent delivery zones, according to some embodiments of the present invention.

The foregoing and other features of the invention will become more readily apparent from the following detailed description, which proceeds with reference to the accompanying drawings.

### DETAILED DESCRIPTION OF THE EMBODIMENTS

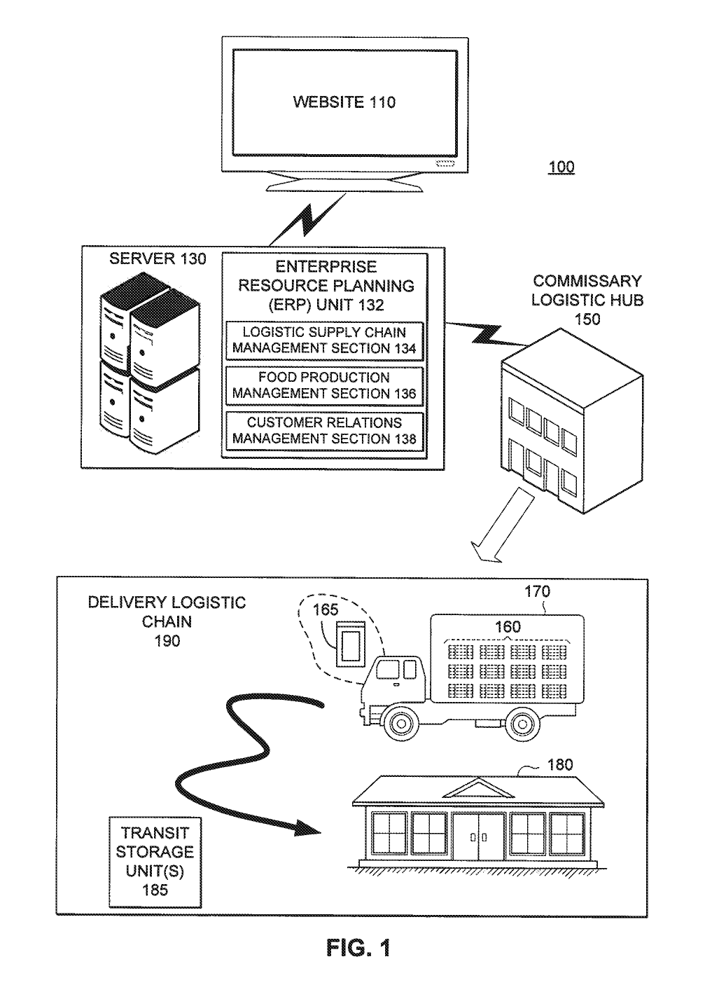

FIG. 1 illustrates an adaptive food catering processing and delivery system 100 including a website 110, a server 130, a commissary 150, and a delivery logistic chain 190, according to some embodiments of the present invention.

Orders for food can be received via the website 110 associated with an interactive network such as the Internet. A server 130 provides the website 110 to a customer who places a catering order via the website 110. The server 130 receives the catering order and transmits a message to a person located in the commissary 150 regarding the order. The term “commissary” should be interpreted broadly and can include a physical building, food production equipment, personnel, and information technology infrastructure, among other suitable components. While the server 130 is shown separate from the commissary 150, it should be understood that the server can be located at or near the commissary 150. Order fulfillment takes place at the commissary 150 or other food preparation facility. Once prepared, the order is delivered to a delivery location 180 using one or more delivery vehicles 170, which carry the boxes 160 according to a predefined plan, as further explained below. Each container 160 can comprise a specially designed catering box, which can include food packaged therein, such as those described in U.S. application Ser. No. 12/615,186, the specification of which is herein incorporated by reference. While the containers 160 are generally referred to herein as “boxes” or “catering boxes,” it should be understood that the containers 160 need not be boxes in the traditional sense, and can be a container of any composition, shape, and size. As used herein, the term “box” or “boxes” generally refer to the container in addition to food elements packaged therein; however, in some embodiments, the boxes are empty and waiting to be populated with the food elements.

The website 110 provides customers with real-time selection of product and delivery time window availability. In other words, customers can select products for purchase, and then select a date and time of delivery. Customers can place an order several days in advance, for example, up to 14 days or more in the future. Customers can also check the status of pending orders, historical orders, credit line balance, and/or check and update the status of their account. The website also provides invoices for products and services rendered, and a means to make payment by the customer. Customers can also track the order from the commissary 150, to the delivery vehicle 170, and finally to the delivery location 180. Other information provided by the website 110 can include date and time of past deliveries, cancellations and modifications of orders, credit line limits, balances due, and payments received.

New customers can open an account using website 110 and establish whether they are a corporate or residential customer. In particular, the delivery location is entered by the customer and an automatic check is performed by server 130 to determine whether the delivery location is located within a predefined delivery zone. If not located within one of the predefined delivery zones, an offer can be made to the customer to place an order and pick up the order from a retail location or other pick up location.

Unique characteristics that are self-evident to the customer and which may be useful in facilitating delivery are entered by the customer and stored by the server 130. For instance, the delivery location may be on floor 14 of the building, through the 3rd door on the left after exiting the elevator. As another example, a temporary parking location may be conveniently located near the south doors of the building. This type of information can be entered by the customer, or may later be associated with the delivery location during the course of subsequent deliveries, and entered and stored in the server 130.

The server 130 includes an enterprise resource planning (ERP) unit 132, which centralizes information regarding order, customers, production, inventory, vehicle fleet, etc. Commissary 150 is a logistic hub. It plays an important role in the quick and efficient dispatching of waves of delivery vehicles 170 departing throughout the day to various delivery zones within their respective delivery shifts, as is described in additional detail below.

A logistic chain stretches from the commissary 150 to the delivery location 180, and is the primary location for food preparation. Food elements (e.g., such as bite-sized or “gem” sized food elements) are prepared and packaged into boxes and are stored as unsold inventory. As orders are received via the website 110, labels are printed and attached to each box. The labels may include, for example, a barcode to identify the order, among other suitable information. At this point, the boxes may be sorted by delivery zone and delivery shift, and, although still at the commissary, the prepared product has entered the logistic chain that stretches to the customer. The bar code on each label can allow precise determination where a particular box resides at each step of the delivery process, for example: time of departure from commissary 150, time of delivery at customer office or home 180, and for those boxes that transit via a neighborhood storage unit 185, the time of arrival and departure from the storage units 185. This information can be provided to customers via the website 110 so that the customer can be kept apprised of the status and progress of the order.

The ERP unit 132 can include a logistic supply chain management section 134, a food production management section 136, and a customer relations management section 138. The food production management section 136 stores and processes information related to raw material purchases, food production planning, finish inventory tracking, labor input tracking, and other suitable operations. For example, the food production management section 136 can store and process information related to one or more food elements and/or one or more associated boxes, whether stored as sold or unsold product inventory, etc.

The customer relations management section 138 stores and processes information related to order management, customer data, payment processing, website interface control, and other suitable operations. For instance, the customer relations management section 138 can store and process information related to one or more food catering orders received through the website 110, accept and process credit card payments, deduct payments from customer accounts, provide historical information about orders, etc.

The logistic supply chain management section 134 stores and processes information related to delivery zone mapping and scheduling, fleet management, order routing optimization, and box tracking, among other suitable operations. For example, the logistic supply chain management section 134 can process input received by the ERP unit 132 and suggest adjustments that can be made to the delivery zone or the delivery shift responsive to the processed input.

The logistics supply chain management section 134 of the ERP unit 132 also manages the delivery logistic chain 190. Delivery vehicles 170 leave the commissary 150 with prepared product inventory for delivery to the customer. In dense or urban areas, deliveries can be made directly from the commissary 150 to the delivery location 180 using relatively larger vehicles having multiple delivery personnel in each vehicle. This ensures high-volume and efficient delivery within these topographies. Conversely, in dispersed residential areas, the prepared inventory associated with one or more catering orders can be stored in transit storage unit(s) 185, thereby pre-staging or temporarily storing the inventory closer to its final destination. From the transit storage unit(s) 185, relatively smaller delivery vehicles (i.e., smaller than the vehicles used in the dense urban areas), can be used in a “capillary” type distribution system to reach the more dispersed residential delivery locations. This multi-stage system provides an organized, low-cost, and fuel-efficient process for distributing food catering orders to relatively remote and farther removed locations.

Delivery personnel within the delivery vehicles 170 may each carry a mobile transceiver 165 for communication with the server 130. The mobile transceivers 165 can be, for example, hand-held scanners, cell phones, walky-talkies, personal digital assistants (PDAs), portable printers, payment processors, and/or any combination thereof. The transceivers 165 can download information related to each delivery shift and all the orders for that shift. When at any of the delivery locations, the delivery personnel have access to all the details about the order they are making, and can mark the order as completed, and the actual time of completion, along with the client signature if necessary. If a question arises regarding the accuracy of an order (e.g., customer thought he had ordered 3 boxes whereas he is receiving 4, and the customer is unaware of a change order by someone else from their office, etc.), the delivery personnel have the information at their instant perusal so that they can dispel any confusion with the customer.

In addition, the server 130 can maintain and adjust delivery profiles and schedules, store payment and customer account information, manage inventory, manage fleet capacity, optimize routes and/or delivery zones, track orders, receive change orders and adjust schedules accordingly, and store mapping and zone information in a database, among other suitable operations.

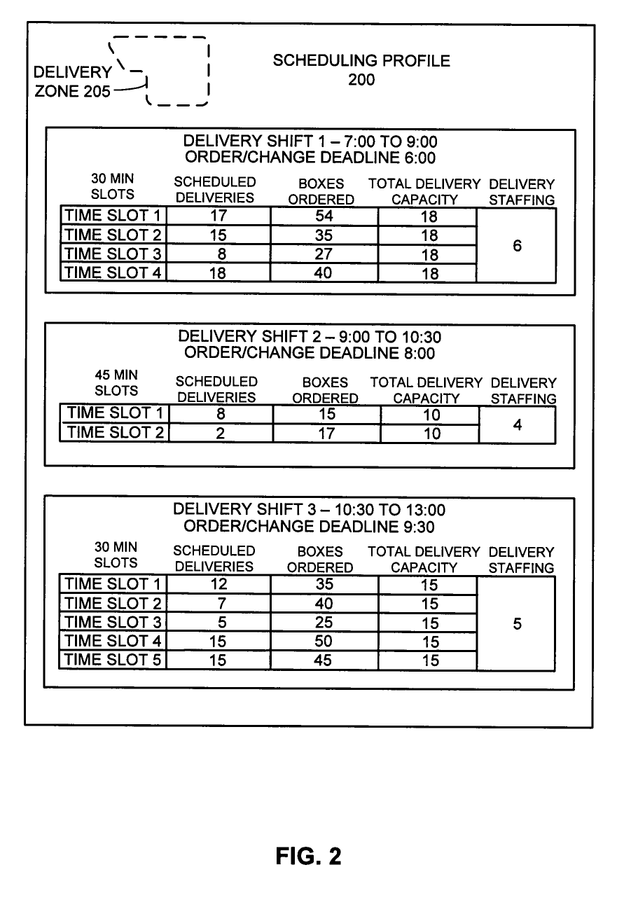

FIG. 2 illustrates a simplified diagram of a scheduling profile 200 associated with a delivery zone 205 in connection with delivery capacity and other factors, according to some embodiments of the present invention.

The delivery zone 205 is preferably a geographic area, generally smaller than a zip code, the perimeters of which are defined with precision on a street-by-street basis. In other words, individual streets define the outer boundary of the delivery zone 205. While the delivery zone 205 is preferably located in a high density area such as downtown areas of a city, it should be understood that the delivery zone can be located in residential areas, or in any geographic location. Moreover, the delivery zone 205 can be of any size.

In delivery zones that are primarily located in corporate or densely populated areas, transit storage units are generally not needed or used, but rather, deliveries are made directly from the commissary to the delivery location. Moreover, the size of the delivery zone 205 is determined at least in part by the ability of a delivery vehicle to move from one end to the other end of the delivery zone within one time slot. In residential or dispersedly populated areas, the logistic model can incorporate a neighborhood transit storage unit (such as 185 of FIG. 1), and a capillary distribution from the transit storage unit, using smaller vehicles going from delivery to delivery along the route. The geographic dimensions of the delivery zone 205 is determined at least in part by the need for all delivery points within that zone 205 to be within a predefined number of minutes (e.g., 15, 20 or 30 minutes, etc.) from the transit storage unit.

The server 130 can store a mapping database having multiple delivery zones. Associated with each delivery zone is a scheduling profile, such as scheduling profile 200. The scheduling profile 200 includes multiple delivery shifts (e.g., shift 1, shift 2, and shift 3). As illustrated in FIG. 2, delivery shift 1 is between 7:00 and 9:00; delivery shift 2 is between 9:00 and 10:30; and delivery shift 3 is between 10:30 and 13:00. It should be understood that these are exemplary delivery shifts and need not be limited thereto. The length or characteristics of each delivery shift is adjustable. Indeed, the number, length, or other characteristics of each delivery shift may be viewed, set, or otherwise modified. Each delivery zone can have a rolling timeframe in which to accept orders, for example, a two-week rolling period.

Each delivery shift has associated therewith an order/change deadline. For instance, example, delivery shift 1 has an order/change deadline of 6:00; delivery shift 2 has an order/change deadline of 8:00; and delivery shift 3 has an order/change deadline of 9:30. The order/change deadline is a “minimum advanced notice” and indicates the latest time in which a new order or a change to an order will be accepted through the website 110 for a given delivery shift. This ensures that new orders and change orders can effectively and reliably be entered and delivered.

The order/change deadlines are set to essentially coincide with the departure of delivery vehicles from the commissary plus sufficient time to load vehicles, etc. For instance, a delivery shift that stretches from 8:00 to 10:00 can have an order/change deadline of 7:00. Working backwards, 8:00 is the time the first delivery must be made, 7:45 is the time the vehicle leaves the commissary, between 7:00 and 7:45 boxes are readied to be loaded, before 7:00 additions or changes to orders are received and implemented, boxes are loaded, delivery route is finalized and printed, etc.

Delivery shift scheduling characteristics will vary depending on the characteristics of the delivery zone. For example, if the delivery zone is in a predominantly corporate district, then the length of the delivery shift is preferably 2 hours or thereabout, and the multiple shifts will span the entire day, for example, from around 7:30 through 17:00; generally the shifts will be weekday only. Conversely, if the delivery zone is in a predominantly residential area, the delivery shifts will be fewer and shorter; for example, one delivery shift from 18:00 to 20:00 can be made available, and only on Friday, Saturday, and Sunday. For a mixed corporate/residential delivery zone, a combination of delivery shift characteristics from both corporate and residential can be used. Customers can modify or cancel all or part of an order as long as the deadline is met.

Corporate delivery zones preferably have an order/change deadline of one hour or thereabout before the start of a delivery shift. In other words, if a particular order is set to be delivered between 8:00 and 8:30 and the delivery shift is from 7:00 to 9:00, then the latest a customer may cancel, modify, or place a new order, is 6:00. Thus, changes to the number of scheduled deliveries and/or the boxes ordered value are prevented after the order/change deadline for a given delivery shift has passed.

In contrast, residential delivery zones preferably have an order/change deadline of 3-4 hours before the start of a delivery shift. Consider the case of a delivery to a neighborhood transit storage unit that can be centrally located in a particular residential delivery zone. Also assume that there is a single delivery shift on Fridays from 18:00 to 20:00 (i.e., a time that is likely to coincide with small private parties within private homes). Here, the transit storage unit will be supplied with finished inventory during off peak hours, that is, before 16:00 on the day of delivery (i.e., Friday). Accordingly, the order/change deadline for that delivery shift will be set at 15:00, which can coincide with the time that the delivery vehicle that supplies the transit storage unit departs the commissary. In this case, the order/change deadline is 3 hours before the start of the delivery shift.

Each delivery shift includes multiple delivery time windows or time slots (e.g., time slot 1, time slot 2, etc.). Each time slot can be, for example, 30 minutes, 45 minutes, or 60 minutes in length. It should be understood that the time slots can be of any suitable length, and are adjustable. Each time slot has associated therewith a total delivery capacity, or in other words, the number of total deliveries that can be performed within the delivery zone and delivery shift during the particular time slot.

Optimization of delivery routes occurs within each delivery time window and to a certain extent adjacent windows. Customers select a time window and therefore dictate within predefined parameters (e.g., total delivery capacity) where the deliveries are expected to go during that time window. The route optimization entails deciding the sequence of deliveries within that time window. If a customer selects time window 10:00 to 10:30, the actual delivery window can be 9:45 to 10:30. An order that is delivered 15 minutes before the reserved time window can be considered an “on time” delivery.

Different delivery shifts can have different total delivery capacities. For example, time slot 1 of delivery shift 1 has a total delivery capacity of 18 deliveries and time slot 4 of delivery shift 3 has a total delivery capacity of 15 deliveries. Generally, the total delivery capacity is identical for all time slots within a given delivery shift because the number of delivery personnel on duty for a given delivery shift is common across the shift. The total delivery capacity is associated with a delivery staffing level. In other words, a total delivery capacity of 18 can be associated with a delivery staffing level of 6 delivery personnel. A delivery manager can view the running number of deliveries to occur per delivery time slot, delivery shift, and/or for each delivery zone in order to ensure a sufficient level of delivery personnel and other delivery resources (i.e., a sufficient total delivery capacity). The total delivery capacity can be treated as “inventory” that is replenished on a daily basis and depleted as customers book specific delivery time slots. Indeed, the total delivery capacity can be increased or reduced accordingly. For instance, when the scheduled deliveries are equal to or greater than the total delivery capacity for a given time slot, the delivery staffing level can be increased. Moreover, the number, length, or other characteristics of each time slot may be viewed, set, or otherwise modified.

As delivery reservations (i.e., catering orders) are booked across a delivery shift, parameters of the various time slots are updated. For example, the scheduled deliveries count increases for the various time slots as new deliveries are scheduled. Specifically, as shown in FIG. 2, time slot 2 of delivery shift 1 has received 15 orders and time slot 4 of the same delivery shift has received 18 orders, for example. Thus, the delivery capacity “inventory” of time slot 4 is depleted, although time slot 2 has the capacity to receive 3 additional orders. The depleted delivery capacity of time slot 4 can be replenished by adjusting the delivery personnel and other resources on a daily or even hourly basis. Indeed, the delivery capacity “inventory” can be impacted by new orders, change orders, and cancellations, and therefore, the total delivery capacity can be adjusted at any time to account for dynamic ordering scenarios.

When a customer places an order, the customer orders one or more boxes. The boxes can be for example, specially designed catering boxes as mentioned above. The total number of 30 boxes ordered is tracked for each time slot. For example, time slot 2 of delivery shift 1 has received orders totaling 35 boxes. As another example, time slot 4 of delivery shift 3 has received orders totaling 50 boxes. Tracking the total number of boxes ordered aids in inventory management and planning. A catering manager has real-time access to evaluate unsold inventory, and can increase or decrease production accordingly. Furthermore, the catering manager can track the total number of boxes ordered but not sold for lack of product (i.e., inventory), and/or track the total number of orders requested but not satisfied for lack of delivery personnel (i.e., delivery capacity “inventory”).

More specifically, tracking the total number of boxes ordered and to be delivered within a time slot enables the catering manager to spot larger than usual orders. Generally, for individual orders including a smaller number of boxes (e.g., 1 to 4 boxes), a single delivery person can handle the order and delivery, and in addition, the delivery person can “set out” the boxes (e.g., open the boxes and reveal the bite-sized food elements to the customer) without the need for additional personnel. Conversely, if an individual order includes a higher number of boxes (e.g., 15 or more boxes), multiple delivery personnel might be needed to deliver and set out the boxes. Tracking the total number of boxes that have been ordered and that are to be delivered per time slot alerts the catering manager of such an occurrence, which would otherwise not be the case if only the number of deliveries per time slot were tracked.

A customer may want to change a delivery time window, for example, from 8:00 to 8:30 to 8:30 to 9:00. The change would need to be made before the order/change deadline for the associated delivery shift. Moreover, the change would be subject to availability, that is, it would depend on whether there is sufficient delivery capacity remaining for the particular time slot selected. If the customer attempts to change the order to a time slot that is full (i.e., the delivery capacity “inventory” is exhausted), then an offer can be made to the customer for delivery within an alternate time slot, and/or an offer is made for the customer to pick up the order from the nearest retail outlet or other pick up location. Similarly, if a particular box is ordered and is unavailable due to actual product inventory depletion, an offer can be made for an alternate type of box of similar kind or quality.

When a customer initiates placing an order through the website 110, it is determined whether the delivery location is within an available delivery zone. If not within an available delivery zone, an offer is made to the customer to place a “pick up” order from a retail location and a map showing the nearest retail location is automatically provided. Otherwise, the customer proceeds to select a date and delivery time window (i.e., time slot) for the order. If the selected time slot is not available, the customer is given alternatives. For instance, an offer can be made to the customer to select any other time slot that is available in the same delivery shift including time slots immediately before and after the selected time slot. Alternatively, or in addition to, an offer is made to the customer to pick up the order from a retail outlet or other pick up location, similar to that mentioned above. The system can track the number of missed sales transactions resulting from the lack of delivery capacity for a given time slot, which can help determine advantageous changes to the scheduling profile.

When a customer chooses to pick up a catering order from retail outlet or other pickup location, the website 110 queries the customer to select or otherwise indicate a pick up time window. This information is provided to personnel working at the retail outlet. In this manner, the personnel at the retail outlet can plan for and handle various levels of pick-up activity with less disruption to other retail activities such as selling food elements directly to walk-in customers.

As part of placing the order, the customer specifies which type of box to order (e.g., “savory,” “sweet,” etc.) and quantity. As mentioned above, if the product inventory for a particular box is depleted, an offer is made to the customer to select from other non-depleted boxes. The system can track the number of missed sales transactions resulting from lack of product inventory, which can help determine advantageous changes to the amount of inventory produced.

In this manner, the customer can be guaranteed that an order will be received, filled, and delivered within a precise window of time and including precisely what the customer ordered.

After placing the order, a variety of actions can be triggered. The order is received by the server 130 and an order label or barcode is printed, preferably at the commissary 150. The label or barcode can include information such as:
Customer name
Delivery address or retail outlet location in case of retail pickup
Delivery zone
Delivery shift
Delivery time slot
Total number and type of boxes ordered
Special delivery instructions
Delivery-specific characteristics of a delivery location

The order is added to a specific delivery shift associated with the delivery zone having the delivery location, all of which can be stored in server 130. Once the label is placed on a catering box, the box has transitioned from unsold to sold inventory, and enters the logistics chain, even though it has not yet left the commissary. A delivery address is added to a delivery route associated with the particular time slot of the delivery shift so that the delivery personnel can find the location. If it is a “pick up” order, a retail location can be notified about the order for pick up by the customer. In addition, adjustments are made to the inventory of boxes stored or being prepared at the commissary, and the scheduled deliveries are updated, within the limits of the delivery capacity.

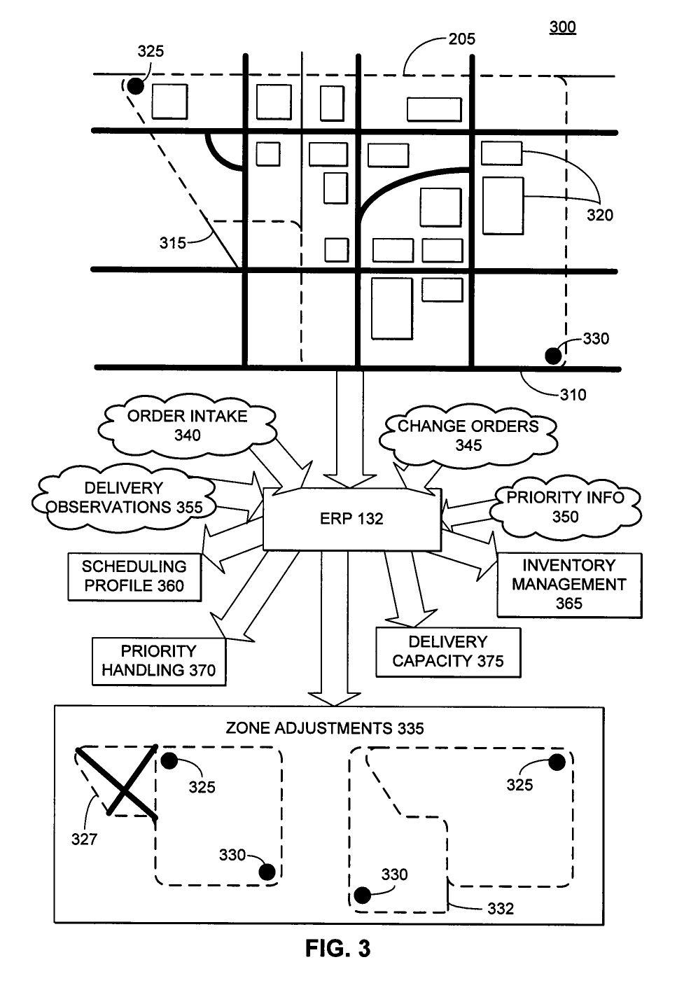

FIG. 3 illustrates a simplified diagram of various components of an adaptive food catering processing and delivery system 300 according to some embodiments of the present invention. The ERP unit 132 can be comprised of computer hardware, software, firmware, remote handheld units, or any combination thereof. It should be understood that the ERP unit 132 can be operatively coupled to or included in the server 130.

The perimeter of delivery zone 205 can be defined on a street-by-street basis, as previously mentioned above. More specifically, a major street 310 can define one portion of the perimeter and minor streets 205 and 315 can define other portions of the perimeter. It should be understood that any number of streets, roads, highways, avenues, etc. can define the totality of the perimeter of any given delivery zone. Generally, there will be buildings 320 located within the delivery zone, which themselves can be delivery locations, or can include delivery locations therein (e.g., specific rooms or convention areas within the buildings).

Points 325 and 330 are conceptual points located at two opposite ends of the delivery zone 205. An initial or estimated drive-time calculation for end-to-end zone traversal can be determined under typical driving conditions. In some embodiments, this determination can be inputted into the ERP unit 132, which can be processed and used to determine or adjust, for example, the scheduling profile 360 including driving capacity, time slot length, and so forth. In some embodiments, the estimated drive-time calculation for end-to-end zone traversal can be used to determine the size of delivery zone and/or the length of a time slot. In other words, the size of delivery zone and length of time slot are directly related.

During the course of delivering catered food orders, information can be gathered and input into the ERP unit 132. For example, delivery observations 355 such as actual drive-time determinations can be gathered and entered. The observations can include, for example, whether buildings 320 have security protocols or barriers that might slow delivery operations, whether elevators are particularly slow or otherwise significantly delay the delivery, whether parking procedures impact delivery time, or whether there are convenient parking spaces to use, among other possibilities. Certain times of day may impede deliveries because of increased traffic. Areas within the delivery zone that are experiencing construction can be noted and entered.

These and other observations can be input into the ERP unit 132, which can then process and combine the observations, and thereafter, modify or adjust the scheduling profile 360, delivery capacity 375, inventory management 365, and so forth.

Moreover, the ERP unit 132 can receive order intake 340. The order intake 340 includes, for example, information received from the customer via the website 110. Change orders 345 can also be received by the ERP unit 132. Such information can be used to adjust the scheduling profile 360, delivery capacity 375, inventory management 365, and so forth.

Priority information 350 can also be received by ERP unit 132. Priority information includes, for example, a priority code that is given to customers, which can determine their priority standing in regards to product inventory and delivery time slot availability. Even without a priority code, a recurrent corporate client that orders multiple times per week can be designated as having a higher priority than a customer that orders merely once a month, for example. Customers can be categorized as “priority” or “non-priority” or otherwise assigned a particular level of priority for a particular account. New customers can be assigned a default priority level, which can later be adjusted based on ordering patterns. The priority information 350 can apply to both delivery time slots and to product inventory. For instance, high priority customers can be given preference in the allocation of what is a finite resource of daily product inventory and delivery capacity. A set number of time slots and/or product can be set aside to meet the demand from the high-priority customers.

In some embodiments, priority clients can select from the entire inventory of boxes available at any given time, while non-priority customers can select from a restricted inventory (e.g., a portion of the entire inventory) available at a particular time. The ERP unit 132 can process the priority information and indicate that special priority handling 370 applies to certain customers and/or orders. The ERP unit 132 can also modify the scheduling profile 360, inventory management 365, or delivery capacity 375 based on the priority information.

The ERP unit 132 can also produce suggestions for making zone adjustments 335 based on any of the inputs received. For example, the ERP unit 132 can receive one or more of the inputs discussed above, process or otherwise combine the inputs, and make a determination whether the perimeters of the delivery zone 205 ought to be adjusted. In some example embodiments of the invention, the ERP unit 132 determines that certain orders are falling in an area 332 outside of the existing delivery zone boundaries, and can modify the delivery zone 205, or otherwise suggest modifications thereto, to capture these missed opportunities for increasing orders. Similarly, the ERP unit 132 can recognize that fewer orders are being received in an area 327 than in other areas of the delivery zone 205, and as a result, can shrink the delivery zone 205 to increase efficiency and reduce wasted resources. The conceptual points 325 and 330 can be revised to reflect the new end-boundaries of the delivery zone 205 after any such adjustments to the delivery zone 205.

Changes to delivery zone boundaries, delivery shift length, or time slot length are carefully considered because of their potential negative impact on existing orders and/or the confusion they may create amongst existing customers. Nevertheless, changes to the initial set of parameters will likely occur, such as adding a delivery zone adjacent to one already existing, adding delivery shifts to an existing schedule, and so forth, or even adjusting the boundaries of an existing delivery zone. The embodiments of the present invention contemplate and facilitate such changes without undue impact on existing delivery schedules.

To accommodate the ability of a customer to place an order a number of days (e.g., such as 14 days) in advance, changes to any of the characteristics of a delivery zone or schedule profile can be implemented according to the following guidelines. The change can take place immediately when the change does not impact any of the existing orders. Or, if the change has the potential to impact existing orders, the change can be scheduled to take place in the future when existing orders will not be impacted (e.g., on the day after the day farthest in the future that has an order). During a transitional period, two or more sets of characteristics can be in place for a given delivery zone.

A catering manager can modify all of the characteristics of a delivery zone, including geographic and scheduling characteristics. In addition, the catering manager can set a date for the changes to become effective. One set of characteristics can be applicable to all orders booked up to the date the changes become effective, and another set of characteristics can be applicable to all orders for the period after the effective date. In this manner, during a period of time (such as a 14 day rolling period), two different sets of characteristics may be in either an effective or pending state.

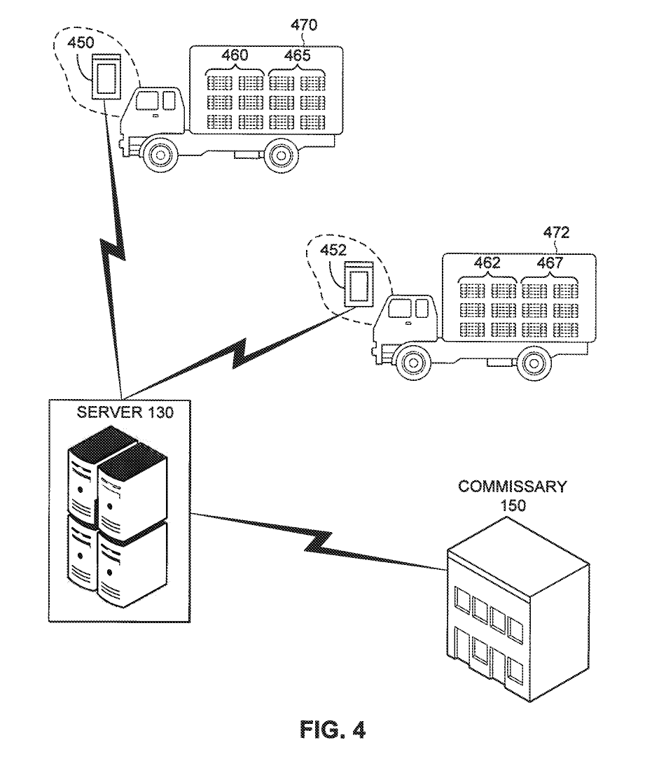

FIG. 4 illustrates a simplified diagram of multiple delivery vehicles 470 and 472, each having product inventory (e.g., 460 and 462) and excess product inventory (e.g., 465 and 467), and including a remote transceiver (e.g., 450 and 452) for communicating with the server 130 of FIG. 1. It should be understood that while two delivery vehicles are illustrated, any number of delivery vehicles can be used in connection with the embodiments of the invention disclosed herein.

In some embodiments of the present invention, delivery personnel carry a remote transceiver such as 450 or 452. The remote transceiver can be communicatively coupled to the server 130 and transmit or receive information to and from the server 130. For instance, the remote transceiver may receive a message including a new incoming order.

Delivery personnel can carry the transceivers 450 or 452 onto which any information related to each delivery shift and all the orders of that shift can be downloaded. At each delivery, the delivery personnel have access to all the details about the delivery they are making. The delivery personnel can mark the order as completed and the actual time of completion along with the client signature if necessary. As previously mentioned, if a question arises, delivery personnel have all pertinent information on hand, and can resolve any disputes with the customer using the information.

Each delivery vehicle 470/472 can include product inventory 460/462, which is already reserved for orders yet to be delivered. In addition, each delivery vehicle can include excess product inventory 465/467 yet to be reserved for any order. When the delivery personnel receive the message on the remote transceiver that the new order has arrived, the excess product inventory can be used to fulfill the order. In other words, if there is sufficient delivery capacity within a particular time slot to fill the new order, then the delivery route for that time slot can be altered and the excess product inventory 465/467 already located within the delivery vehicle 470/472 can be used to fill the order without the delivery personnel needing to return to the commissary 150 for replenishments. Moreover, multiple different varieties of boxes and food elements can be included in the excess inventory to accommodate orders of all types. New label or barcode information can be printed using the remote transceivers 450/452, and applied to one or more of the excess inventory boxes.

The remote transceivers 450/452 may also include a scanner to scan bar code information on each box, and transmit delivery completion information to the server 130. Other information can be communicated between the remote transceivers 450/452 and the commissary 150. In this manner, the database of information stored in the server 130 and the personnel located at the commissary 150 can be kept informed of the delivery operations in progress. The database can be updated in real-time as deliveries occur. Moreover, if there is a dispute with the customer over whether the catering order was accurate and/or delivered on time, information stored and transmitted between the server 130 and the remote transceivers 450/452 can be used to vouch for the accuracy of the order and the actual delivery time, thereby amicably diffusing any confusion or doubt with the customer.

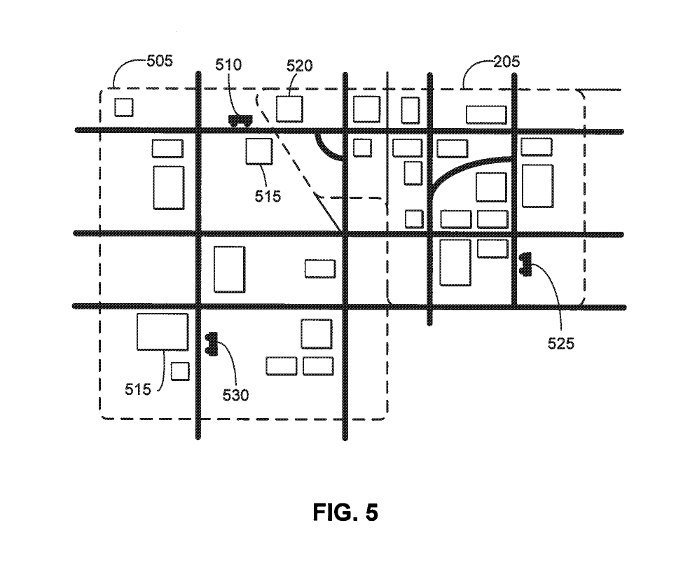

FIG. 5 illustrates a simplified diagram of two adjacent delivery zones 205 and 505, and a technique for cross-boundary delivery management, according to some embodiments of the present invention. Delivery capacity or resources can be “pin-pointed” or otherwise associated with or assigned to a given zone. For example, delivery vehicles 510 and 530 can be associated with or assigned to delivery zone 505 and delivery vehicle 525 can be associated with or assigned to delivery zone 205. Similarly, one group of delivery personnel can be associated with or assigned to delivery zone 505 and another different group of delivery personnel can be associated with or assigned to delivery zone 205. In this manner, total delivery capacity can be precisely identified or designated for each delivery zone and more easily managed on a zone-by-zone basis.

In some embodiments of the invention, some of the delivery capacity associated with or designated to one zone can be temporarily shifted to another zone, and then returned to its previous zone, without permanently changing the boundaries of any zone. For instance, if delivery vehicle 510 is making a delivery to location 515 near the common border of adjacent zones 205 and 505, while delivery vehicle 525 might be making deliveries elsewhere within zone 205, then delivery vehicle 510 can temporarily cross into zone 205 and make a delivery to the proximally located delivery location 520, and then cross back into zone 505. In other words, delivery capacity can be shared between zones, preferably along the border areas dividing the different zones.

The customer need not be aware that delivery capacity sharing is occurring. Indeed, the customer need not be aware of zone boundaries at all, and instead, can enter their delivery location address at the time of ordering, and the deliveries can occur in accordance with the inventive concepts disclosed herein, which can be entirely transparent to the customer.

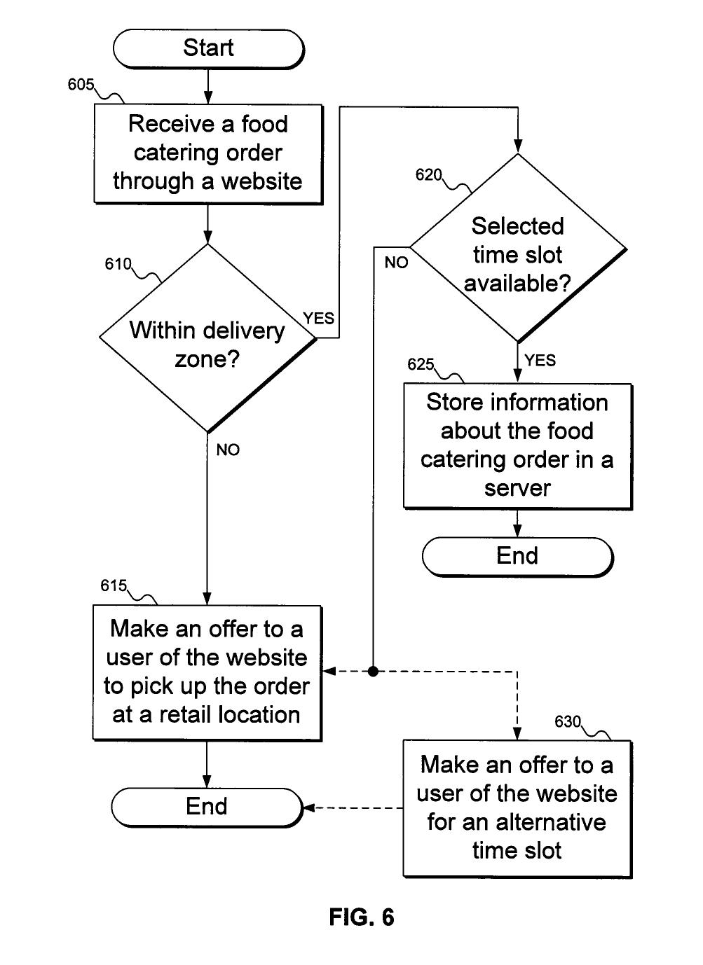

FIG. 6 is a flow diagram illustrating a technique for receiving food catering orders and making alternative selections to customers, according to some embodiments of the invention. The technique begins by receiving a food catering order through a website at 605. At 610, a determination is made whether the delivery location associated with the order is within a predefined delivery zone. If NO, the flow proceeds to 615 and an offer is made to a user of the website to pick up the order at a retail location or other pick up location. If YES, the flow proceeds to 620. At 620, another determination is made whether the time slot selected by the user of the website is available. If YES, the flow proceeds to 625 and information about the food catering order is saved in a computer server. Otherwise, if NO, the flow proceeds along one of two possible paths. A first path leads to 615 where an offer is made for the customer to pick up the order at the retail or other location. Alternatively, the flow proceeds along a second path to 630 where an offer is made for an alternative time slot.

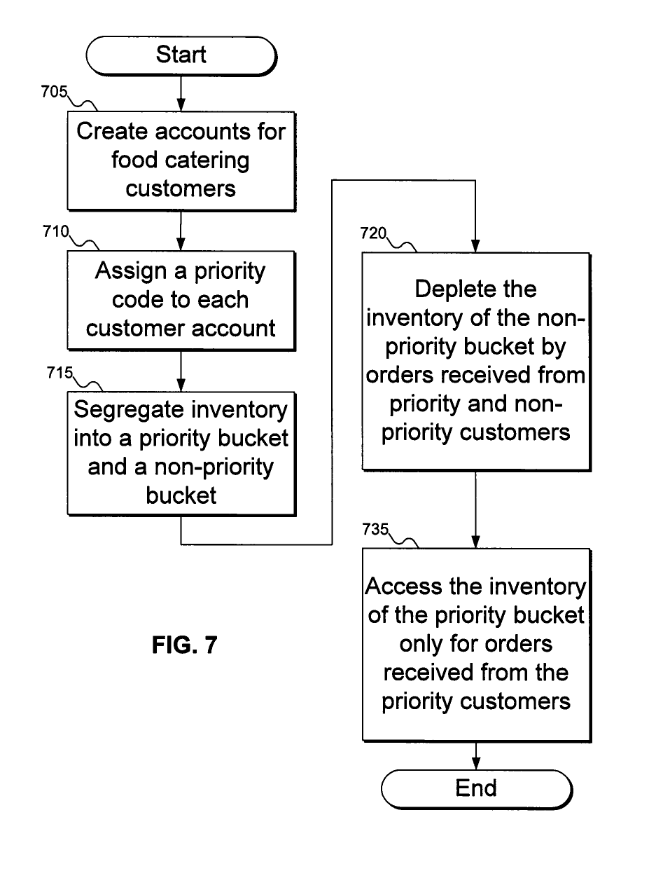

FIG. 7 is a flow diagram illustrating a technique for prioritizing customers and filling orders based on the assigned priorities, according to some example embodiments. The technique begins at 705 where accounts are created for food catering customers. Thereafter, the flow proceeds to 710 and a priority code is assigned to each customer account. The flow then proceeds to 715 and inventory is segregated into or otherwise associated with a priority bucket and a non-priority bucket. At 720, inventory associated with the non-priority bucket is depleted by orders received from priority and non-priority customers. At 735, inventory associated with the second priority bucket is accessed only for orders received from the priority customers, and only after the first bucket has been depleted.

More specifically, customers who have signed up for an account are given or assigned a priority code. On a daily basis both the product inventory and the delivery capacity inventory is segregated into various priority “buckets.” Assume, for example, that on Friday the commissary has on-hand or conveniently available a total inventory of 100 catering boxes. In this case, 75 of the boxes can be segregated as non-priority boxes in a first non-priority “bucket,” and the remaining boxes (i.e. 25) as priority boxes can be segregated in a second priority “bucket.” It should be understood that the term “bucket” should be interpreted broadly to mean any appropriate unit of organization. As orders are taken through the website, all orders from priority and non-priority customers can deplete the non-priority bucket of 75 boxes. When the non-priority bucket exhausted, the remaining priority bucket containing 25 boxes is reserved only for orders placed by priority customers. The delivery capacity inventory can be segregated in a similar fashion.

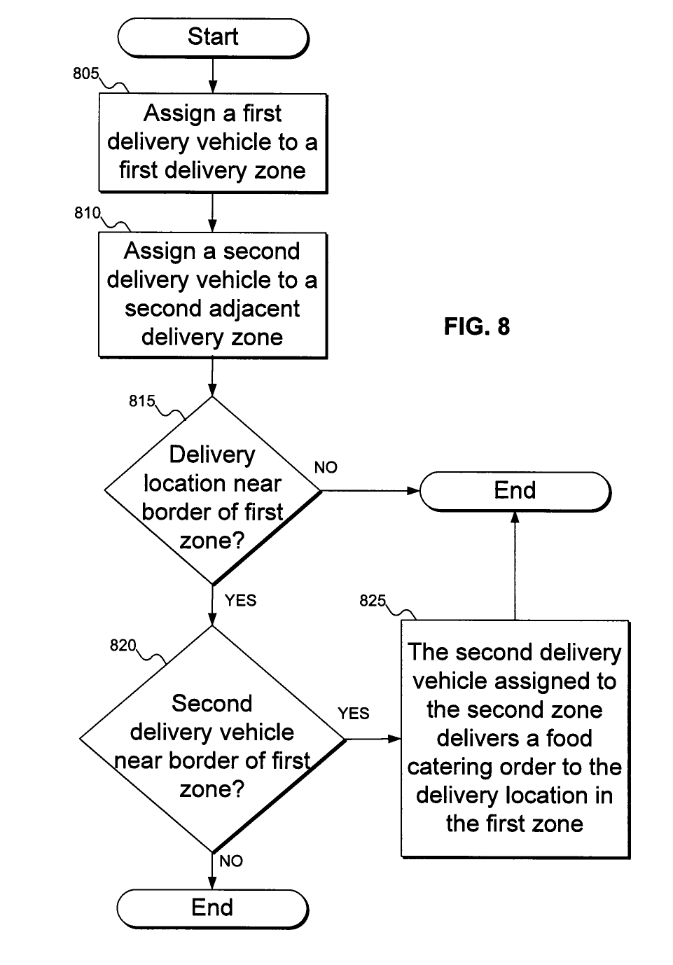

FIG. 8 is a flow diagram illustrating a technique for shifting delivery resources between adjacent delivery zones, according to some embodiments of the present invention. The technique begins at 805 where a first delivery vehicle is assigned to a first delivery zone. At 810, a second delivery vehicle is assigned to a second delivery zone. A determination is made at 815 whether delivery location is near the border of the first zone, but still within the first zone. If YES, the flow proceeds to 820 and another determination is made whether the second vehicle is at or proximally located to the border dividing the first and second zones, and proximally located to the delivery location. If YES, meaning the second delivery vehicle is near to the delivery location located in the first zone, then the second delivery vehicle delivers a food catering order to the delivery location in the first zone even though the second delivery vehicle is normally assigned to the second zone. Therefore, a temporary shifting or sharing of delivery resources can occur between adjacent zones.

Efficient and dependable food catering services can be provided using the systems and method described herein. Although the terms “catering manager,” “inventory manager,” and “delivery personnel,” among other titles, are used throughout, it should be understood that any person having sufficient authority to act can perform any of the appropriate duties or actions as described in the various examples above.

The following discussion is intended to provide a brief, general description of a suitable machine or machines in which certain aspects of the invention can be implemented. Typically, the machine or machines include a system bus to which is attached processors, memory, e.g., random access memory (RAM), read-only memory (ROM), or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciated that network communication can utilize various wired and/or wireless short range or long range carriers and protocols, including radio frequency (RF), satellite, microwave, Institute of Electrical and Electronics Engineers (IEEE) 545.11, Bluetooth®, optical, infrared, cable, laser, etc.

Embodiments of the invention can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Consequently, in view of the wide variety of permutations to the embodiments described herein, this detailed description and accompanying material is intended to be illustrative only, and should not be taken as limiting the scope of the invention.

1. A system for providing adaptive processing and delivery of food catering orders, comprising:
a computer server configured to store schedule information;
a website operatively associated with the computer server and configured to receive one or more food catering orders; and
a commissary to produce one or more food elements and to arrange the one or more food elements into one or more boxes according to the schedule information and responsive to the one or more food catering orders,
wherein the schedule information includes a delivery zone, at least one delivery shift associated with the delivery zone, and a plurality of time slots associated with the at least one delivery shift.

2. The system of claim 1, wherein the website is configured to present a selection to a customer for selecting one of the plurality of time slots from one of the delivery shifts in which a catering order will be delivered.

3. The system of claim 1, further comprising:
a total delivery capacity associated with each of the plurality of time slots; and
a number of requested deliveries associated with each of the plurality of time slots,
wherein the total delivery capacity is adjusted according to the requested deliveries.

4. The system of claim 1, further comprising:
one or more delivery vehicles,
wherein each of the one or more delivery vehicles includes:
inventory designated for existing catering orders;
excess inventory not yet designated for any catering order; and
a transceiver device that is communicatively coupled to the server and configured to receive a new catering order for a delivery location, and
wherein the one or more vehicles are adapted to deliver at least some of the excess inventory to the delivery location responsive to the new catering order.

5. The system of claim 1, further comprising:
a transit storage unit located separate from the commissary to temporarily store the one or more boxes having the food elements arranged therein; and
a delivery vehicle adapted to transfer the one or more boxes from the commissary to the transit storage unit to pre-stage the one or more catering orders.

6. The system of claim 5, wherein the delivery vehicle comprises a first delivery vehicle, the system further comprising:
a second delivery vehicle smaller than the first delivery vehicle, the second delivery vehicle to transfer the one or more boxes from the transit storage unit to a delivery location.

7. The system of claim 1, wherein the computer server includes an enterprise resource planning unit, comprising:
a logistic supply chain management section configured to store and process information related the delivery zone, the at least one delivery shift associated with the delivery zone, and the plurality of time slots associated with the at least one delivery shift;
a food production management section configured to store and process information related to the one or more food elements and the one or more boxes; and
a customer relations management section configured to store and process information related to the one or more food catering orders.

8. The system of claim 7, wherein:
the enterprise resource planning unit is configured to receive input; and
the logistic supply chain management section is configured to process the input, and suggest adjustments to be made to at least one of the delivery zone and the delivery shift responsive to the processed input.

9. The system of claim 7, wherein:
the enterprise resource planning unit is configured to receive input; and
the logistic supply chain management section is configured to process the input, and suggest adjustments to be made to the plurality of time slots responsive to the processed input.

10. The system of claim 7, wherein:
the logistic supply chain management section is configured to change parameters associated with at least one of the plurality of time slots, wherein the parameters include at least one of a scheduled number of deliveries, a boxes ordered value, and a total delivery capacity.

11. A method for providing adaptive processing and delivery of food catering orders, comprising:
receiving a food catering order through a website;
determining whether a selected time slot within a delivery schedule is available for the food catering order;
when the selected time slot is available, storing information about the food catering order in a server; and
when the selected time slot is not available, making an offer to a user of the website for an alternative time slot.

12. The method of claim 11, further comprising:
determining whether a delivery location associated with the food catering order is within the perimeters of a delivery zone; and
when the delivery location is within the perimeters of the delivery zone, delivering one or more boxes based on the food catering order to the delivery location that is located within the delivery zone, and within the selected time slot; and
when the delivery location is not within the perimeters of the delivery zone, making an offer to a user of the website to pick up the food catering order from a retail location.

13. The method of claim 11, further comprising:
detecting food catering orders received for locations outside of a delivery zone; and
increasing a size of the delivery zone to include the outside locations.

14. The method of claim 11, further comprising:
assigning first delivery resources to a first zone;
assigning second delivery resources to an adjacent second zone; and
temporarily shifting at least some of the first delivery resources to the second zone.

15. The method of claim 14, wherein:
the first delivery resources include a first delivery vehicle;
the second delivery resources include a second delivery vehicle; and
temporarily shifting the at least some of the first delivery resources to the second zone includes the first delivery vehicle delivering the food catering order to a delivery location in the second zone.

16. The method of claim 11, further comprising:
creating accounts for food catering customers;
assigning a priority code to each customer account, wherein the priority code indicates one of a priority customer and a non-priority customer;
segregating inventory into a first non-priority bucket and a second priority bucket;
depleting the inventory associated with the first non-priority bucket by orders received from priority and non-priority customers; and
accessing the inventory associated with the second priority bucket only for orders received from the priority customers.

17. A system for providing adaptive processing and delivery of food catering orders, comprising:
a computer server configured to store a scheduling profile;
a website operatively associated with the computer server and configured to receive one or more food catering orders; and
wherein the scheduling profile includes a plurality of delivery shifts and an order/change deadline associated with each of the plurality of delivery shifts.

18. The system of claim 17, wherein each of the plurality of delivery shifts have associated therewith a number of scheduled deliveries, a boxes ordered value, a total delivery capacity, and a delivery staffing level.

19. The system of claim 18, wherein changes to the number of scheduled deliveries and the boxes ordered value are prevented after the order/change deadline.

20. The system of claim 18, wherein when the number of scheduled deliveries is equal to or greater than the total delivery capacity, the delivery staffing level is increased.
